(19) United States
(12) Patent Application Publication
(10) Pub. No.: US 2011/0239181 A1
(43) Pub. Date: Sep. 29, 2011

(54) WIRING DESIGN METHOD AND COMPUTER-READABLE MEDIUM

(75) Inventor: Taku UCHINO, Yokohama-Shi (JP)

(73) Assignee: KABUSHIKI KAISHA TOSHIBA, Tokyo (JP)

(21) Appl. No.: 13/045,422

(22) Filed: Mar. 10, 2011

(30) Foreign Application Priority Data
Mar. 25, 2010 (JP) 2010-70559

(51) Int. Cl. G06F 17/50

(52) U.S. Cl. 716/130

(57) ABSTRACT

In one embodiment, a wiring design method is disclosed. In the wiring design method, schematic wiring is performed on a substrate, and the substrate includes a first wiring layer with first-direction wiring lines and a second wiring layer with second-direction wiring lines; the substrate is divided into a plurality of tiles; the first wiring layer is divided into partial wiring regions with first-direction wiring lines, the second wiring layer is divided into partial wiring regions with second-direction wiring lines, and each partial wiring region corresponds to the tiles; and when the first-direction wiring lines in the tile overflow, the partial wiring region with second-direction wiring lines corresponding to the tile is changed to the partial wiring region with first-direction wiring lines.

### CROSS-REFERENCE TO RELATED APPLICATION

This application is based upon and claims the benefit of priority from prior Japanese Patent Application No. 2010-70559, filed on Mar. 25, 2010, the entire contents of which are incorporated herein by reference.

### FIELD

Embodiments of the present invention relate to wiring design methods for a board and computer-readable medium.

### BACKGROUND

Various wiring boards (substrate), such as a semiconductor chip including a semiconductor integrated circuit, a wiring board of a semiconductor package, and printed circuit boards (PCBs) of various electrical devices, normally include a plurality of wiring layers where wiring lines are routed.

To reduce wiring design time, a technique of automatically designing wiring by an automatic wiring design tool is used. By this, the time required to design wiring can be reduced.

However, in such an automatic wiring design tool, the wiring direction on each wiring layer is fixed over the entire wiring layer. Specifically, for example, in a wiring layer with a first direction, the direction in which wiring lines extend is the first direction over the entire wiring layer.

When wiring is designed using such an automatic wiring design tool, if a wiring layer has a region where wiring lines are congested, then the design process returns to a state before performing the wiring design, and a floor plan is reconsidered or a wiring layer itself is newly added. In this manner, the wiring design using the automatic wiring design tool is carried out. Therefore, even if using the automatic wiring design tool, it is difficult to avoid the tendency to lengthen design time.

### BRIEF DESCRIPTION OF THE DRAWINGS

FIG. 1A is a diagram (part 1) for describing first to third embodiments;

FIG. 1B is a diagram (part 2) for describing the first to third embodiments;

FIG. 2A is a diagram (part 1) for describing the first embodiment;

FIG. 2B is a diagram (part 2) for describing the first embodiment;

FIG. 3 is a diagram (part 3) for describing the first embodiment;

FIG. 4 is a flowchart (part 1) showing a wiring design method according to the first embodiment;

FIG. 5 is a flowchart (part 2) showing the wiring design method according to the first embodiment;

FIG. 6 is a flowchart (part 3) showing the wiring design method according to the first embodiment;

FIG. 7 is a diagram (part 4) for describing the first embodiment;

FIG. 8 is a flowchart (part 4) showing the wiring design method according to the first embodiment;

FIG. 9 is a flowchart showing a wiring design method according to the second embodiment;

FIG. 10A is a diagram (part 1) for describing the second embodiment;

FIG. 10B is a diagram (part 2) for describing the second embodiment;

FIGS. 11A to 11C are diagrams for describing the third embodiment; and

FIG. 12 is a flowchart showing a wiring design method according to the third embodiment.

### DETAILED DESCRIPTION

In one embodiment, a wiring design method comprising: performing schematic wiring on a substrate, the substrate including a first wiring layer with first-direction wiring lines and a second wiring layer with second-direction wiring lines; dividing the substrate into a plurality of tiles; dividing the first wiring layer into the partial wiring regions with first-direction wiring lines, and dividing the second wiring layer into partial wiring regions with second-direction wiring lines, each partial wiring region corresponding to the tiles; and when the first-direction wiring lines in the tile overflow, changing the partial wiring regions with second-direction wiring lines corresponding to the overflowing tile to the partial wiring regions with first-direction wiring lines.

Embodiments of the present invention will be described below with reference to the drawings. In the description, common parts are denoted by common reference numerals throughout the drawings. Note, however, that the present invention is not limited to the embodiments.

Although here wiring design of wiring lines that connect between circuit blocks (functional blocks, logical blocks, etc.) in a semiconductor integrated circuit such as LPDDR2 (Low Power Double Data Rate 2) is described as an example, the present invention is not limited to such a semiconductor integrated circuit.

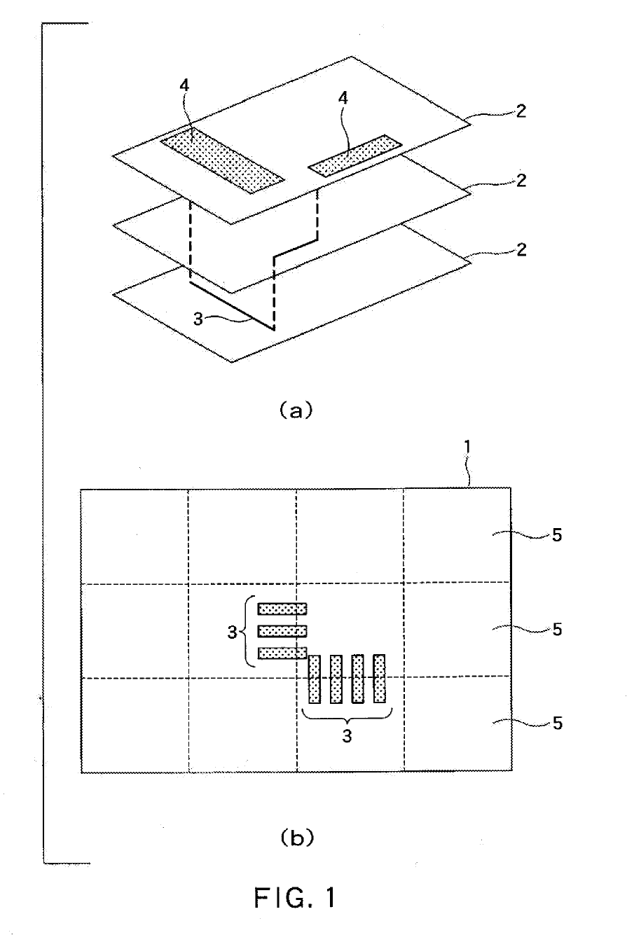

Before describing the embodiments of the present invention, a problem with conventional wiring design will be described below using FIGS. 1A and 1B. When wiring design for LPDDR2 is performed by conventional wiring design, many of the circuit blocks of LPDDR2 are elongated rectangles or have an L-shape having elongated rectangles. When designing wiring lines that connect between such circuit blocks, a problem such as that described below may occur.

As shown in FIG. 1A, a plurality of wiring layers 2 are stacked on top of one another. A plurality of circuit blocks 4 are placed atop a stack of the wiring layers 2. A wiring line 3 that connects between the circuit blocks 4 is designed to be routed over the plurality of wiring layers 2. Furthermore, it is determined that directions in which the wiring line 3 can extend on the respective wiring layers 2 (wiring directions) are an X direction (horizontal direction) and a Y direction (vertical direction). Furthermore, it is determined for each wiring layer that the wiring layer has the same wiring direction over the entire surface of the wiring layer.

Note that schematic wiring is called a topology, and is not wiring having specific coordinates on the wiring layers, but refers to wiring where it is determined which one of the sides of a cell 5 (called a G-cell) formed on a board 1 in a virtual manner, such as that shown in FIG. 1B, the wiring lines cross.

Results of schematic wiring design thus obtained may show that the wiring lines are congested in a specific region in the wiring layers. In such a case, conventionally, a floor plan (locations where the circuit blocks are placed) is reconsidered or a wiring layer is newly added, thereby avoiding a state where the wiring lines are congested.

When wiring lines that connect between circuit blocks having such an elongated rectangular shape are designed, in many cases, the wiring lines extending in either direction, the X direction or the Y direction, are concentrated in a specific region in the wiring layers, and thus, the wiring lines are congested in the specific region in the wiring layers. Means for solving the above-described problem will be described below.

### First Embodiment

Next, a first embodiment of the present invention will be described using FIGS. 1A and 1B to 8.

An overview of the first embodiment will be described below.

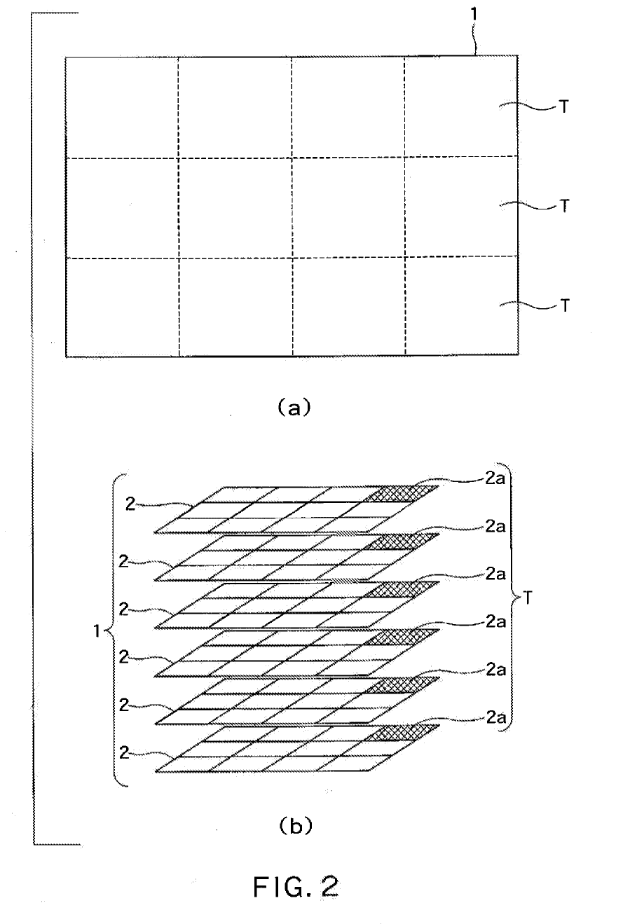

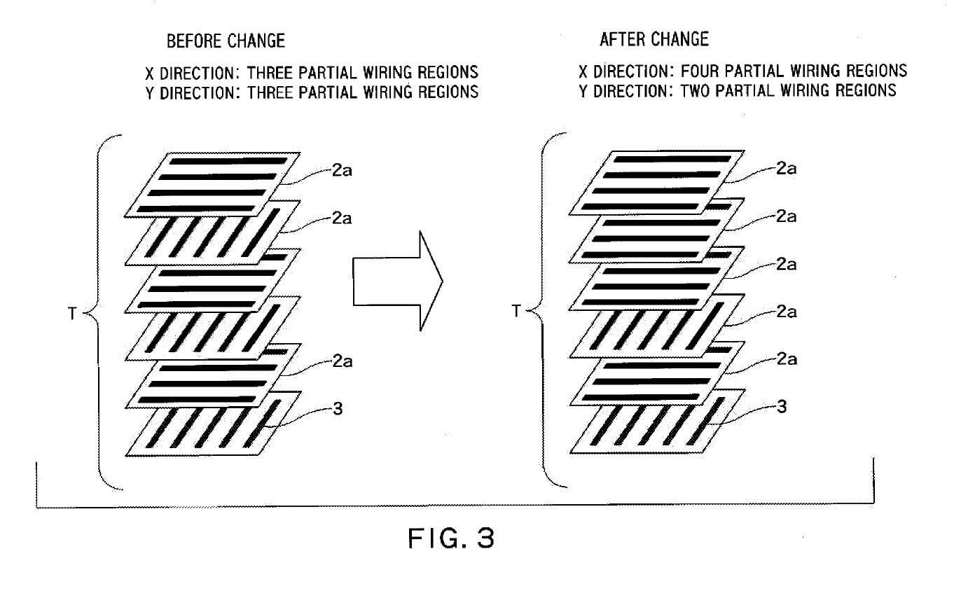

First, a board 1 includes a plurality of wiring layers stacked on top of one another. Schematic wiring design is performed such that it is temporarily determined for each wiring layer that the wiring lines extend in the same wiring direction over the entire surface of the wiring layer. Then, as shown in FIG. 2A, the board 1 is divided in a virtual manner into portions with a predetermined size, thereby forming a plurality of tiles T in a virtual manner. By this, each tile T includes, as shown in FIG. 2B, a plurality of partial wiring regions 2a which are parts of the respective wiring layers 2 and which have coordinates corresponding to the each tile T. Then, in the case in which there is a tile T whose number of wiring lines 3 for each wiring direction which is calculated by schematic wiring exceeds a predetermined number (in the case in which there is overflow), as shown in FIG. 3, the wiring directions of a plurality of partial wiring regions 2a included in the tile T are changed if necessary. Namely, a region in the wiring layers where the wiring lines are congested is detected according to predetermined rules, and the wiring direction of the region is changed.

Next, a detail of the first embodiment will be described. Here, wiring design for a semiconductor integrated circuit, specifically, wiring design of wiring lines between circuit blocks will be described as an example. Note, however, that the present invention is not limited to a semiconductor integrated circuit and can also be used for a wiring board of a semiconductor package, a PCB board, etc. Note also that the application of the present invention is not limited to the wiring design of wiring lines that connect between circuit blocks, and can also be used for the wiring design of other wiring lines.

First, a board and wiring lines will be described. The board includes a plurality of wiring layers. A plurality of circuit blocks are placed on the wiring layers. Furthermore, a plurality of wiring lines used to electrically connect between the circuit blocks are routed over the wiring layers. The wiring directions of the wiring lines are defined in advance. Here, the wiring directions are defined to be an X direction (horizontal direction) and a Y direction (vertical direction) intersecting the X direction at right angle, which are parallel to the sides of the plane of the wiring layers, respectively. However, in the present invention, the wiring directions are not limited to the X direction and the Y direction, and may include a slanting direction inclined 45° to the sides of the plane of the wiring layers, i.e., the wiring directions can be any as long as they are limited to a plurality of predetermined directions.

Next, preparations to perform a wiring design method of the present embodiment will be described. First, the shape and size of each circuit block, a connection relationship between the circuit blocks, and how the circuit blocks are placed on a wiring board (floor plan) are determined. Furthermore, based on these pieces of information, the number of wiring layers and wiring directions on the respective wiring layers are determined. At this time, in each wiring layer, the wiring direction is the same throughout the wiring layer.

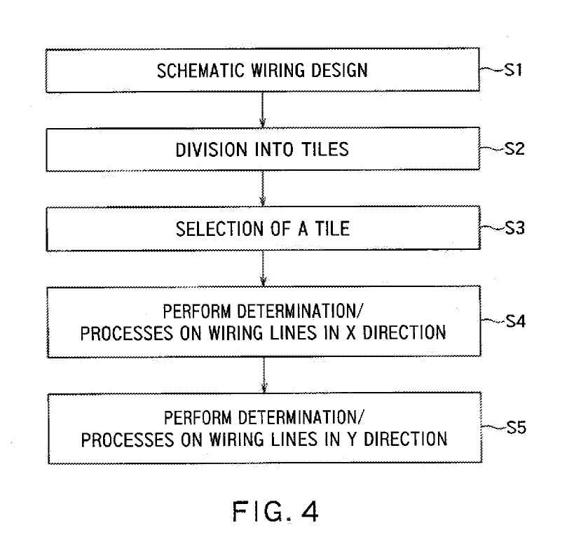

Next, wiring is performed using the wiring design method of the present embodiment. The wiring design method of the present embodiment roughly includes the following five steps. The flow of the five steps is shown in a flowchart in FIG. 4. The steps are as follows.

(Step 1) Schematic wiring design

(Step 2) Division into tiles

(Step 3) Selection of a tile

(Step 4) Determination/processes for wiring lines in the X direction (the wiring direction of a wiring layer is locally changed)

(Step 5) Determination/processes for wiring lines in the Y direction

Furthermore, in the wiring design method of the present embodiment, after the series of steps is performed, steps 3 to 5 are repeated until processes are performed on all tiles.

Steps 1 to 5 specifically include the following steps.

(Step 1)

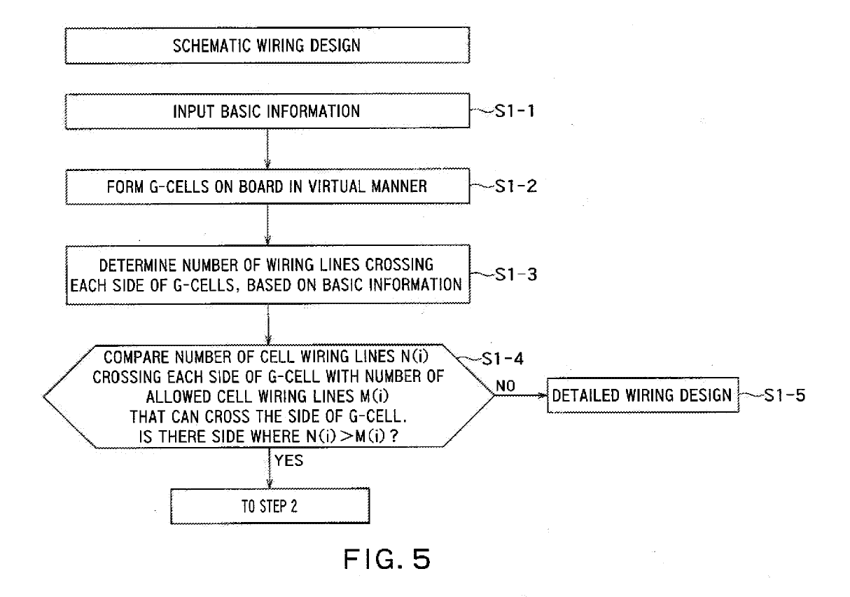

Steps included in the “schematic wiring design” at step 1 will be described using a flowchart in FIG. 5. A method for schematic wiring design related to step 1 which will be described below is an example and thus other methods for schematic wiring design may be used.

(Step 1-1) The shape and size of each circuit block, a connection relationship between the circuit blocks, a floor plan, the number of wiring layers, wiring directions on the respective wiring layers, etc., are input to an automatic wiring design tool. Then, the method proceeds to step 1-2.

(Step 1-2) Next, using the automatic wiring design tool, schematic wiring design is performed based on the input information. In this step, virtual cells (G-cells) are provided on a board 1 to perform schematic wiring design.

Specifically, as shown in FIG. 1B, virtual square cells called G-cells 5 are provided on the board 1. The size of squares (cells) on the G-cells 5 can be arbitrarily selected. For example, the size can be selected taking into account the area of the board, the number of wiring lines, design time, etc. The G-cells 5 are used to estimate the degree of wiring line congestion upon schematic wiring.

Then, the method proceeds to step 1-3.

(Step 1-3) Based on the input data, the automatic wiring design tool determines, as shown in FIG. 1B, which one of the sides of a G-cell 5 wiring lines 3 that connect between the circuit blocks cross. That is, schematic wiring design is performed. Results of the schematic wiring design obtained here are used later and thus are stored as data. Then, the method proceeds to step 1-4.

(Step 1-4) It is determined whether the number of wiring lines crossing each side of each G-cell 5 (called the number of cell wiring lines N (i)) is appropriate.

Specifically, the number of wiring lines that can cross each side of each G-cell 5 (called the number of allowed cell wiring lines M (i)) is determined according to design rules, the number of wiring layers, etc. This value is input to the automatic wiring design tool in advance. Note that the design rules are rules that the wiring lines on the wiring layers need to follow. An example of the design rule is that the spacing between wiring lines needs to be set to a value greater than or equal to a determined value.

If a side where the number of cell wiring lines N(i) exceeds the number of allowed cell wiring lines M(i) is not detected, then the method proceeds to step 1-5.

On the other hand, if a side where the number of cell wiring lines N (i) exceeds the number of allowed cell wiring lines M(i) is detected, then the method proceeds to step 2.

(Step 1-5) Detailed wiring design is performed based on the results of the schematic wiring design obtained at step 1-3. The detailed wiring refers to wiring where specific coordinates on the board are determined based on the results of schematic wiring design. After the detailed wiring design is completed, the wiring design is completed, and thus, the series of processes ends.

(Step 2)

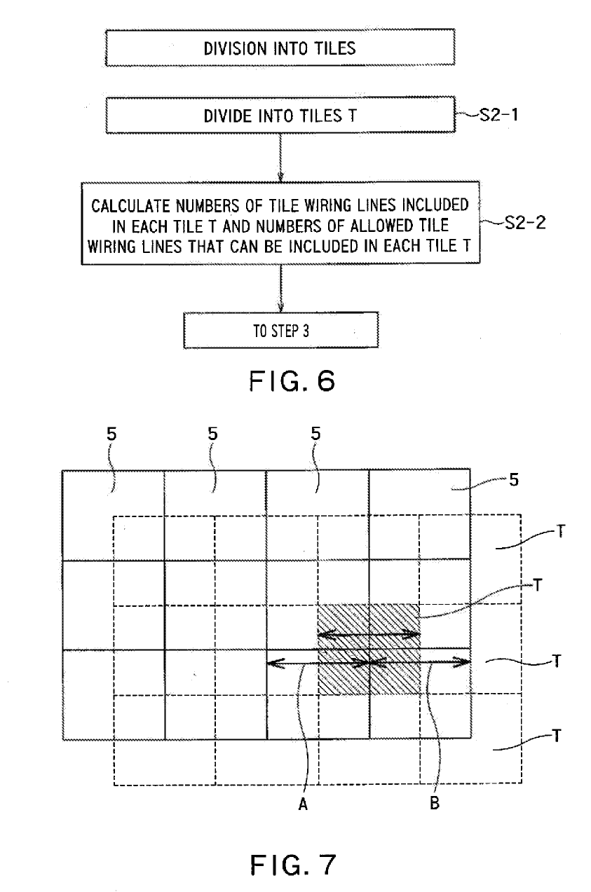

Steps included in the “division into tiles” at step 2 will be described using a flowchart in FIG. 6. Note that a method of forming a plurality of tiles related to step 2 which will be described below is an example and thus other methods of forming tiles may be used.

(Step 2-1) Virtual square tiles used to perform a next process are formed on the board 1 using the G-cells 5 formed in a virtual manner at step 1-2. Note that although here a method of forming virtual square tiles by shifting the G-cells 5 is described, virtual square tiles may be formed using the G-cells 5 as they are or may be formed without using the G-cells 5. When tiles are formed using the G-cells 5 as they are, for example, the number of tile wiring lines which will be described later is the number of cell wiring lines N(i), and the number of allowed tile wiring lines which will be described later is the number of allowed cell wiring lines M(i).

The method of forming tiles from the G-cells 5 will be described using FIG. 7. As shown in FIG. 7, the squares of the G-cells 5 are shifted in phase by half a square in both an X direction (a horizontal direction in FIG. 7) and a Y direction (a vertical direction in FIG. 7), thereby forming new squares in a virtual manner where tiles T are to be formed. In other words, new squares which are the contours of tiles T are formed such that each point at which sides on G-cells 5 intersect is located at the center of a tile T.

Specifically, as shown in FIG. 7, a tile T includes, taking a look at the X direction, parts of two sides on G-cells 5 extending in the X direction, i.e., a half of side A and a half of side B. For the Y direction, too, as with the X direction, the tile T includes halves of respective two sides on G-cells 5 extending in the Y direction.

Here, one square is called a tile T. Each tile T includes, as shown in FIG. 2B, a plurality of partial wiring regions 2a which are parts of the respective wiring layers 2 and which are corresponding to the tile T.

Forming tiles T by shifting the squares of the G-cells 5 facilitates calculation of the numbers of wiring lines included in each tile T, using the results of schematic wiring design performed using the G-cells 5, a detailed of which will be described later.

Then, the method proceeds to step 2-2.

(Step 2-2) In this step, the numbers of wiring lines for the respective wiring directions that are included in each the T (the numbers of the wiring lines) and the maximum numbers of wiring lines for the respective wiring directions that can be included in each tile T (the numbers of allowed tile wiring lines) are calculated.

For easy description of calculation methods, as an example, calculation of the numbers of wiring lines included in a tile T shown in FIG. 7 (the numbers of tile wiring lines), and calculation of the maximum numbers of wiring lines that can be included in the tile T (the numbers of allowed tile wiring lines) will be described.

As shown in FIG. 7, a tile T includes therewithin parts of sides on two G-cells 5 extending in the X direction, i.e., a part of side A and a part of side B. Here, as an example, the results of schematic wiring design obtained at step 1-3 show that the number of wiring lines in the Y direction crossing the side A (the number of cell wiring lines in the Y direction) is 3 (N(A)=3), and likewise, the number of wiring lines in the Y direction crossing the side B (the number of cell wiring lines in the Y direction) is 4 (N(B)=4).

Then, a sum total of the numbers of wiring lines in the Y direction crossing sides that are included in part in the tile T (the numbers of cell wiring lines in the Y direction) is calculated, and ½ of the value of the sum total is assumed to be the number of wiring lines in the Y direction included in the tile T (the number of tile wiring lines in the Y direction). Specifically, in the case of the above-described example, the number of wiring lines in the Y direction included in the tile T is: {N(A)+N(B)}×½, and thus, in the case of the tile T shown in FIG. 7, the number of wiring lines in the Y direction included in the tile T is: (3+4)×½=3.5.

Then, likewise, the maximum number of wiring lines in the Y direction (the number of allowed tile wiring lines in the Y direction) is calculated for the tile T shown in FIG. 7. For the sides A and B included in the tile T, as described above, the numbers of wiring lines that can cross the respective sides A and B (the numbers of allowed cell wiring lines) are determined in advance, according to the number of wiring layers and the wiring directions on the wiring layers. Here, the number of allowed cell wiring lines for the side A is M(A) and the number of allowed cell wiring lines for the side B is M(B). In such a case, the maximum number of wiring lines in the Y direction for the tile T shown in FIG. 7 (the number of allowed tile wiring lines in the Y direction) is: {M(A)+M(B)}×½, as with the calculation of the number of wiring lines (the number of tile wiring lines in the Y direction).

The number of wiring lines in the X direction (the number of tile wiring lines in the X direction) and the maximum number of wiring lines in the X direction (the number of allowed tile wiring lines in the X direction) for the tile T are calculated by the same methods as those described so far.

The numbers of wiring lines (the numbers of tile wiring lines) and the maximum numbers of wiring lines (the numbers of allowed tile wiring lines) which are calculated here are stored as data. Then, the method proceeds to step 3.

(Step 3)

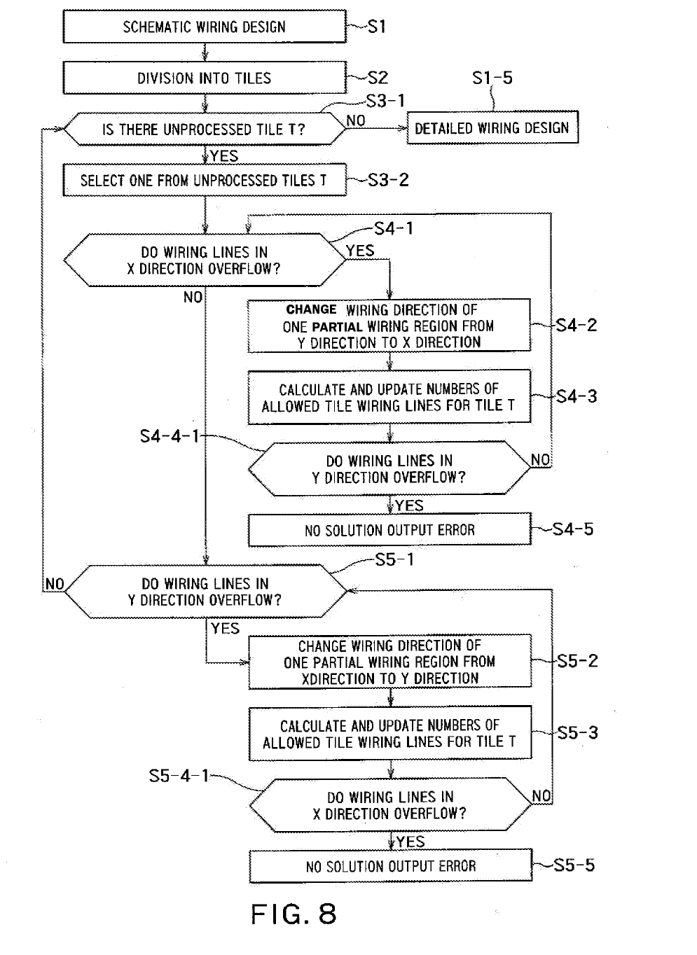

Steps included in the “selection of a tile” at step 3 will be described using a flowchart in FIG. 8.

(Step 3-1) It is determined whether there are tiles T that are not subjected to processes which will be described from now on. At this time, if there are no unprocessed tiles T, then the method returns to step 1-5 where detailed wiring design is performed. On the other hand, if there are unprocessed tiles T, then the method proceeds to step 3-2.

(Step 3-2) One unprocessed tile T (which is not subjected to processes described from now on) is selected from the plurality of tiles T formed at step 2. Thereafter, a series of processes is performed focusing on the selected tile T. Then, the method proceeds to step 4-1.

(Step 4)

Steps included in the “determination/processes for wiring lines in the X direction” at step 4 will be described using the flowchart in FIG. 8.

(Step 4-1) It is determined for the tile T selected at step 3-2 whether the wiring lines in the X direction overflow.

Here, for one tile T, the numbers of wiring lines for the respective wiring directions that are included in the tile T (the numbers of tile wiring lines), which are calculated at step 2-2, are respectively compared with the maximum numbers of wiring lines for the respective wiring directions that can be included in the T (the numbers of allowed the wiring lines), which are calculated at step 2-2 as well. If the number of wiring lines is larger than the corresponding maximum number of wiring lines, then it is defined that the wiring lines in the corresponding wiring direction overflow.

If the wiring lines in the X direction do not overflow, then the method proceeds to step 5-1 to perform processes for the wiring lines in the Y direction. On the other hand, if the wiring lines in the X direction overflow, then the method proceeds to step 4-2.

(Step 4-2) In this step, if it is determined at step 4-1 that the wiring lines in the X direction overflow, then one of a plurality of partial wiring regions 2a included in the selected the T is selected, and the wiring direction of the selected partial wiring region 2a is changed (the wiring direction is locally changed).

As described at step 2, each tile T includes a plurality of partial wiring regions 2a which are parts of the respective wiring layers 2 and which are corresponding to the coordinates of the tile T, such as those shown in FIG. 2B. Therefore, one partial wiring region 2a whose wiring direction is the Y direction is selected from among a plurality of partial wiring regions 2a included in the tile T for which it is determined that the wiring lines in the X direction overflow. Then, the wiring direction of the selected partial wiring region 2a is changed from the Y direction to the X direction.

At this time, for example, as shown in FIG. 3, the partial wiring regions 2a are sequentially selected one by one from the top of a stack of the partial wiring regions 2a, and the wiring direction of the selected partial wiring region 2a is changed. However, for example, the partial wiring region 2a may be sequentially selected one by one from the bottom of a stack of the partial wiring regions 2a, and the wiring direction of the selected partial wiring region 2a may be changed. The selection order can be any as long as one partial wiring region 2a is selected in accordance with a predetermined order and the wiring direction of the selected partial wiring region 2a is changed. By doing so, the same process can also be performed for adjacent another tile T, enabling to reduce a state where adjacent tiles T have different configurations of partial wiring regions 2a (a combination of partial wiring regions 2a whose wiring directions are the X direction and partial wiring regions 2a whose wiring directions are the Y direction in a plurality of partial wiring regions 2a included in each tile T), in other words, a state where the wiring directions of adjacent partial wiring regions 2a differ between adjacent tiles T.

Then, the method proceeds to step 4-3.

(Step 4-3) In this step, since the wiring direction of one partial wiring region 2a has been changed at step 4-2, the values of the maximum numbers of wiring lines for the respective wiring directions that can be included in the selected tile T (the numbers of allowed tile wiring lines) are accordingly changed.

Specifically, description is made using the example shown in FIG. 3. There are six partial wiring regions 2a included in the tile T. Specifically, there are three partial wiring regions 2a whose wiring directions are the X direction, and there are three partial wiring regions 2a whose wiring directions are the Y direction. Furthermore, here, one partial wiring region 2a can include four wiring lines at the maximum. Therefore, before a change, for the tile T, the maximum number of wiring lines (the number of allowed tile wiring lines) is 12 for both of the wiring lines in the X and Y directions.

However, since the wiring direction of one partial wiring region 2a has been changed, in the tile T, there are four partial wiring regions 2a whose wiring directions are the X direction, and there are two partial wiring regions 2a whose wiring directions are the Y direction. Therefore, in the tile T, the maximum number of wiring lines in the X direction is 16 and the maximum number of wiring lines in the Y direction is 8. Namely, the maximum numbers of wiring lines (the numbers of allowed tile wiring lines) are changed.

Accordingly, the maximum numbers of wiring lines for the respective wiring directions for the selected tile T (the numbers of allowed tile wiring lines) are calculated again by the same procedure as that described at step 2-2. The calculated values are used later as the updated maximum numbers of wiring lines, and thus, are stored as data. Then, the method proceeds to step 4-4-1.

(Step 4-4-1) Next, after the wiring direction of one partial wiring region 2a has been changed at step 4-2, it is determined whether the wiring lines in the Y direction in the selected tile T overflow. For the maximum number of wiring lines (the number of allowed tile wiring lines) used at this time, the one calculated at step 4-3 is used. If the wiring lines in the Y direction do not overflow, then the method returns to step 4-1. On the other hand, if the wiring lines in the Y direction overflow, then the method proceeds to step 4-5.

(Step 4-5) If it is determined at step 4-4-1 that the wiring lines in the Y direction overflow, then there is no solution and thus the automatic wiring design tool outputs an error. Thereafter, the series of processes end.

Then, until there is no determination that the wiring lines in the X direction overflow, steps 4-1 to 4-5 are repeated. In such a repetition, as described above, for example, as shown in FIG. 3, the partial wiring regions 2a are sequentially selected one by one from the top of a stack of the partial wiring regions 2a, and the wiring direction of the selected partial wiring region 2a is changed. However, the order is not limited thereto, and the order can be any as long as the wiring direction of a partial wiring region 2a is changed in accordance with a predetermined order.

If, as a result of repeating steps 4-1 to 4-5, there is no determination that the wiring lines in the X direction overflow, then the method proceeds to step 5-1.

(Step 5)

Steps included in the “determination/processes for wiring lines in the Y direction” at step 5 will be described below. The steps included in step 5 are similar to those included in step 4, and thus, detailed description thereof is omitted. Note that step 5 is shown in the flowchart in FIG. 8.

(Step 5-1) In this step, it is determined for the tile T selected at step 3-2 whether the wiring lines in the Y direction overflow.

At this time, when step 4-3 has not been performed, the maximum number of wiring lines (the number of allowed tile wiring lines) calculated at step 2-2 is used. On the other hand, when step 4-3 has been performed, the maximum number of wiring lines updated at step 4-3 is used.

If the wiring lines in the Y direction do not overflow, then the method returns to step 3-1 to select an unprocessed tile T. On the other hand, if the wiring lines in the Y direction overflow, then the method proceeds to step 5-2.

(Step 5-2) In this step, if it is determined at step 5-1 that the wiring lines in the Y direction overflow, then one partial wiring region 2a whose wiring direction is the X direction is selected from among a plurality of partial wiring regions 2a included in the selected tile T, and the wiring direction of the selected partial wiring region 2a is changed from the X direction to the Y direction. In the same manner as above, for example, as shown in FIG. 3, the partial wiring regions 2a are sequentially changed from the top of a stack of the partial wiring regions 2a. However, the order is not limited thereto, and the order can be any as long as the wiring direction of a partial wiring region 2a is changed in accordance with a predetermined order.

Then, the method proceeds to step 5-3.

(Step 5-3) In this step, since the wiring direction of one partial wiring region 2a has been changed at step 5-2, the values of the maximum numbers of wiring lines for the respective wiring directions that can be included in the selected tile T (the numbers of allowed tile wiring lines) are accordingly changed. Thus, as described at step 4-3, the maximum numbers of wiring lines are calculated again. The calculated values are used later as the updated maximum numbers of wiring lines, and thus, are stored as data. Then, the method proceeds to step 5-4-1.

(Step 5-4-1) Next, after the wiring direction of one partial wiring region 2a has been changed at step 5-2, it is determined whether the wiring lines in the X direction in the tile T overflow. For the maximum number of wiring lines (the number of allowed tile wiring lines) used at this time, the one calculated at step 5-3 is used. If the wiring lines in the X direction do not overflow, then the method returns to step 5-1. On the other hand, if the wiring lines in the X direction overflow, then the method proceeds to step 5-5.

(Step 5-5) If it is determined at step 5-4-1 that the wiring lines in the X direction overflow, then there is no solution and thus the automatic wiring design tool outputs an error. Thereafter, the series of processes end.

Then, until there is no determination that the wiring lines in the Y direction overflow, steps 5-1 to 5-5 are repeated. In such a repetition, as described above, for example, as shown in FIG. 3, the partial wiring regions 2a are sequentially selected one by one from the top of a stack of the partial wiring regions 2a, and the wiring direction of the selected partial wiring region 2a is changed. However, the order is not limited thereto, and the order can be any as long as the wiring direction of a partial wiring region 2a is changed in accordance with a predetermined order.

If, as a result of repeating steps 5-1 to 5-5, there is no determination that the wiring lines in the Y direction overflow, then the method returns to step 3-1.

Then, until there is no more unprocessed tile T, steps 3-1 and 3-2, steps 4-1 to 4-5, and steps 5-1 to 5-5 are repeated. If there is no more unprocessed tile T, then the schematic wiring design is completed and the method returns to step 1-5 to perform detailed wiring design.

Wiring design results can be obtained in the above-described manner.

Accordingly, by doing this, wiring design can be performed easily without adding a wiring layer or reconsidering a floor plan. Furthermore, the present embodiment is effective in wiring design for connecting between circuit blocks which are elongated rectangles or which have an L-shape having elongated rectangles.

Variants of the present embodiment are as follows.

In the present embodiment, one tile T is randomly selected at step 3-2, it is determined for the selected tile T whether there is overflow, and then, processes (consideration and change of the wiring directions) are performed. On the other hand, in a variant, first, determination as to whether there is overflow may be made for each tile T and each wiring direction, and then, a tile T that is to be subjected to a series of processes may be selected from among tiles T for which it is determined that there is overflow.

Furthermore, first, determination as to whether there is overflow may be made for each tile T and each wiring direction and calculation of the number of wiring lines that exceeds the maximum number of wiring lines (the number of allowed tile wiring lines) may be performed for each tile T and each wiring direction. Then, a tile T may be selected in descending order of the number of wiring lines that exceeds the maximum number of wiring lines, and a series of processes may be performed on the tile T.

When, for example, wiring design takes a long time, only some tiles T whose numbers of wiring lines exceeding the maximum number of wiring lines are largest may be selected, and a series of processes may be performed on the tiles T.

### Second Embodiment

Next, a second embodiment of the present invention will be described using FIGS. 8 to 10A and 10B. Note that description of the same steps as those in the first embodiment is omitted.

A wiring design method of the present embodiment is shown in a flowchart in FIG. 8, and a tile T shown in FIG. 8 is replaced by a tile Tg of the present embodiment which will be described later.

The present embodiment differs from the first embodiment in that wiring design is carried out using a tile Tg which is a group of tiles T of the first embodiment. By this, in the second embodiment, the “division into tiles” at step 2 differs from that in the first embodiment. Thus, here, the “division into tiles” at step 2 will be described in detail. Note that, in the following description, a tile in the first embodiment is referred to as a tile T and a tile in the present embodiment is referred to as a tile Tg.

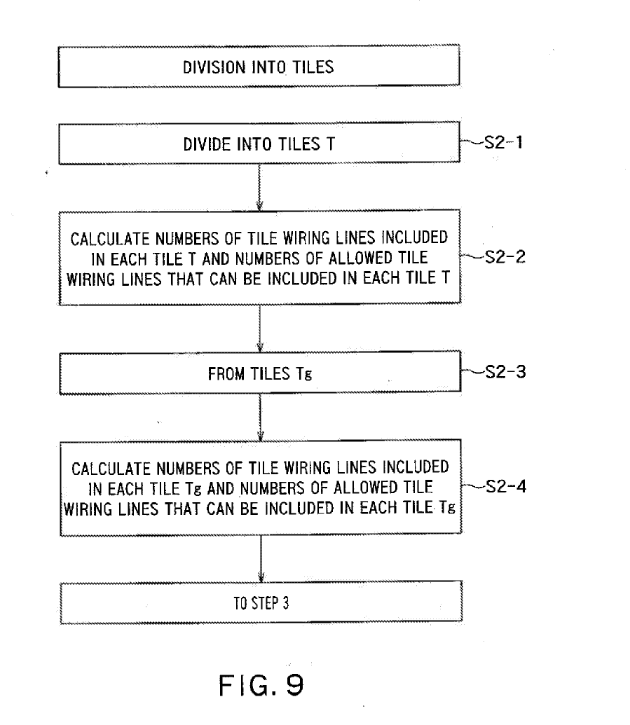

Steps included in the “division into tiles” at step 2 will be described using FIG. 9. As shown in FIG. 9, steps where the numbers of tile wiring lines and the numbers of allowed tile wiring lines for a tile Tg are calculated include steps 2-3 and 2-4 which will be described below, in addition to steps in the first embodiment where the numbers of tile wiring lines and the numbers of allowed tile wiring lines for a tile T are calculated (steps 2-1 and 2-2 (in FIGS. 6, S2-1 and S2-2)).

(Step 2-3) In this step, tiles Tg which are used in later processes are formed in a virtual manner.

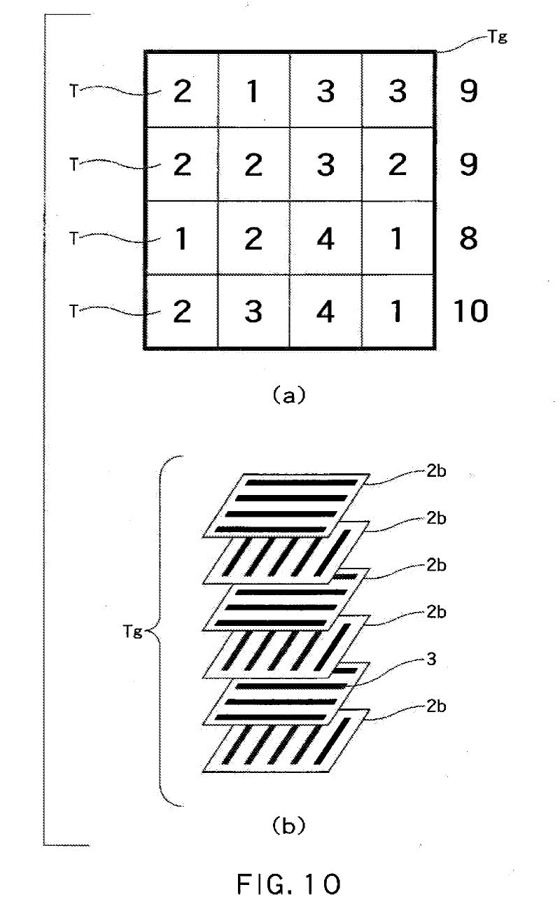

As shown in FIG. 10A, a predetermined number of adjacent tiles T are gathered into a tile Tg of a predetermined size. The number of tiles T forming the tile Tg can be arbitrarily selected, and is input to an automatic wiring design tool taking into account the area of a board, the number of wiring lines, design time, etc. By this, each tile Tg includes, as shown in FIG. 10B, a plurality of partial wiring regions 2b which are parts of respective wiring layers 2 and which have coordinates corresponding to the each tile Tg. Furthermore, each partial wiring region 2b is a group of a plurality of partial wiring regions 2a shown in FIG. 2B (partial wiring regions 2a shown in FIG. 2B) which are parts of the respective wiring layers 2 and which have coordinates corresponding to the plurality of tiles T forming the tile Tg.

Then, the method proceeds to step 2-4.

(Step 2-4) In this step, the numbers of wiring lines for the respective wiring directions that are included in each tile Tg (the numbers of tile wiring lines) and the maximum numbers of wiring lines for the respective wiring directions that can be included in each tile Tg (the numbers of allowed tile wiring lines) are calculated based on the numbers of wiring lines included in the corresponding tiles T (the numbers of tile wiring lines) which are calculated at step 2-2 and the maximum numbers of wiring lines that can be included in the corresponding tiles T (the numbers of allowed tile wiring lines).

Here, the numbers of wiring lines for the respective wiring directions included in the tile Tg (the numbers of tile wiring lines) are obtained as follows. Sum totals are calculated by adding up, for each row (or each column), the numbers of wiring lines in a Y direction (or an X direction) for the tiles T, and the largest one of the calculated values is set as the number of wiring lines for the Y direction (or the X direction) included in the tile Tg. Furthermore, the maximum numbers of wiring lines for the respective wiring directions that can be included in the tile Tg (the numbers of allowed tile wiring lines) are also similarly obtained as follows. Sum totals are calculated by adding up, for each row (or each column), the maximum numbers of wiring lines in the Y direction (or the X direction) for the tiles T, and the smallest one of the calculated values is set as the maximum number of wiring lines for the Y direction (or the X direction) that can be included in the tile Tg.

For easy description of this calculation method, as an example, a method of calculating the number of wiring lines included in a tile Tg shown in FIG. 10A (the number of tile wiring lines) will be described below.

FIG. 10A shows a tile Tg where tiles T are gathered 4 by 4 vertically and horizontally (hereinafter, such an arrangement of tiles T is represented as 4×4). The number in each tile T shown in FIG. 10A indicates the number of wiring lines in the Y direction included in the tile T which is obtained at step 2-2. In addition, the number shown on the right side of each row of tiles T (in FIG. 10A, there are four tiles T in each row) indicates a sum total of the numbers of wiring lines in the Y direction included in the tiles T of that row. For example, for the topmost row in FIG. 10A, the number of wiring lines in the Y direction included in that row is a sum total of the numbers of wiring lines in the row and thus is: 2+1+3+3=9. When calculation is performed for the others in the same manner, sum totals for the rows are respectively 9, 9, 8, and 10 from the top.

Furthermore, the number of wiring lines in the Y direction for the tile Tg shown in FIG. 10A (the number of tile wiring lines in the Y direction) is the largest value among the sum totals of the numbers of wiring lines in the Y direction for the respective rows, and thus, is 10.

In addition, the maximum number of wiring lines in the Y direction (the number of allowed tile wiring lines in the Y direction), the number of wiring lines in the X direction (the number of tile wiring lines in the X direction), and the maximum number of wiring lines in the X direction (the number of allowed tile wiring lines in the X direction) for each tile Tg are calculated by the same methods as those described above.

The numbers of wiring lines and the maximum numbers of wiring lines (the numbers of allowed tile wiring lines) which are calculated here are stored as data. Then, the method proceeds to step 3.

The numbers of tile wiring lines and the numbers of allowed tile wiring lines for each tile Tg are calculated in the above-described manner. Subsequent steps, i.e., the “selection of a tile” at step 3, the “determination/processes for wiring lines in the X direction” at step 4, and the “determination/processes for wiring lines in the Y direction” at step 5, can be described in the same manner as in the first embodiment by replacing a tile T in the first embodiment by a tile Tg in the present embodiment, and thus, description thereof is omitted.

Note that although at step 2 of the present embodiment a method of forming a tile Tg using tiles T is described, a tile Tg may be formed without using tiles T.

As such, in the present embodiment, wiring design is performed using tiles Tg, each of which is a group of tiles T. Thus, compared with the first embodiment, the time required for wiring design can be further reduced.

Furthermore, the variants of the first embodiment can also be applied to the present embodiment.

### Third Embodiment

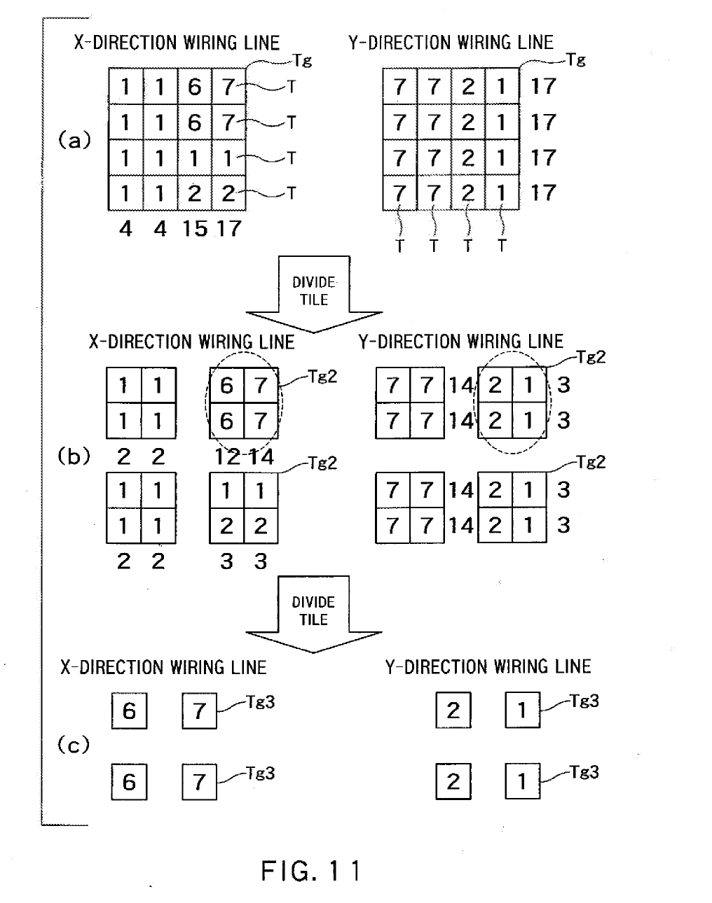

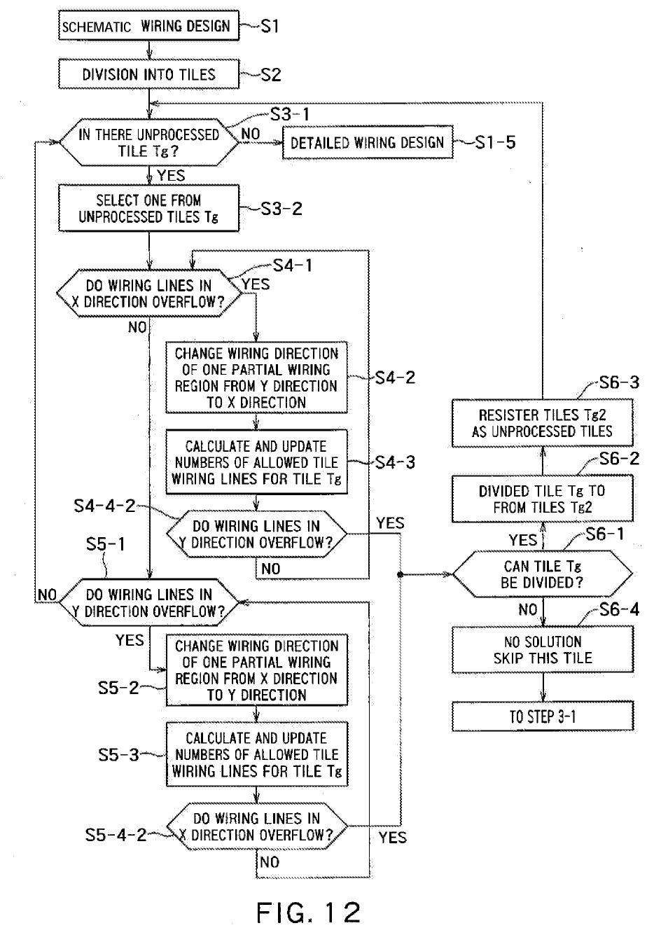

Next, a third embodiment of the present invention will be described using FIGS. 11A to 11C and 12. Note that, in the following description, a tile in the first embodiment is referred to as a tile T and a tile in the second embodiment is referred to as a tile Tg.

The present embodiment differs from the second embodiment in that wiring design is carried out in a manner such that a selected tile Tg is further divided where necessary, to form a plurality of tiles (secondary tiles) Tg2.

Before describing the present embodiment, description is made of the fact that wiring design can be effectively performed by thus forming a plurality of tiles Tg2 by dividing a tile Tg.

In the second embodiment, to design wiring, the configuration of partial wiring regions (a combination of partial wiring regions whose wiring directions are an X direction and partial wiring regions whose wiring directions are a Y direction in a plurality of partial wiring regions included in each tile Tg) is determined for each tile Tg. Therefore, the larger the size of the tile Tg, the smaller the number of locations whose wiring directions are changed. Thus, wiring design is facilitated, enabling to reduce the time required for wiring design.

However, as in an example such as that shown below, in a tile Tg, since the wiring lines in the X direction and the wiring lines in the Y direction are both congested, a solution to the wiring design cannot be obtained. However, by making the tile Tg into small portions by division, a solution to the wiring design may be able to be obtained.

Such an example will be described below using FIGS. 11A to 11C. FIG. 11A shows a tile Tg (a tile Tg in the second embodiment) formed by gathering 4×4 tiles T (tiles T in the first embodiment). Furthermore, the tile Tg includes eight partial wiring regions 2b, specifically, four partial wiring regions 2b whose wiring directions are the X direction, and four partial wiring regions 2b whose wiring directions are the Y direction. Therefore, each tile T includes four partial wiring regions 2a whose wiring directions are the X direction, and four partial wiring regions 2a whose wiring directions are the Y direction.

Here, it is assumed that the maximum number of wiring lines that can be included in each partial wiring region 2a is 1. Thus, from the configuration of the partial wiring regions 2a included in each tile T, the maximum number of wiring lines that can be included in each tile T (the number of allowed tile wiring lines) is 4 for both the X direction and the Y direction. Furthermore, since the tile Tg shown in FIG. 11A is a group of 4×4 tiles T, when the maximum numbers of wiring lines for the tile Tg (the numbers of allowed tile wiring lines) are calculated according to the method described at step 2-4 in the second embodiment, the maximum numbers of wiring lines in the X direction and the Y direction are both 16.

Meanwhile, the numbers shown in the respective tiles T forming the tile Tg, as shown in FIG. 11A, indicate the numbers of wiring lines included in the respective tiles T (the numbers of tile wiring lines), which are obtained from the results of schematic wiring design at step 1. Based on the numbers of wiring lines included in the respective tiles T, the numbers of wiring lines included in the tile Tg (the numbers of tile wiring lines) are calculated using the method described at step 2-4 in the second embodiment. As a result, the number of wiring lines included in the tile Tg is 17 for the wiring lines in the X direction, and is 17 for the wiring lines in the Y direction.

Hence, since the number of wiring lines in the X direction included in the tile Tg (the number of tile wiring lines in the X direction) and the number of wiring lines in the Y direction included in the tile Tg (the number of tile wiring lines in the Y direction) exceed 16 which is the calculated maximum numbers of wiring lines for the tile Tg (the numbers of allowed tile wiring lines), the wiring lines in both the X direction and the Y direction are in a state of overflow.

Namely, in the wiring design method described in the second embodiment, a solution to the design cannot be obtained for the tile Tg shown in FIG. 11A.

However, the tile Tg being in such a state is further divided into tiles Tg2, each of which has tiles T arranged 2×2, such as those shown in FIG. 11B. When the tile Tg is thus divided to form four tiles Tg2, the numbers of wiring lines included in each tile Tg2 (the numbers of tile wiring lines) are as follows. Specifically, the numbers of wiring lines included in the tiles Tg2 (the X direction, the Y direction) are (14, 3), (3, 3), (2, 14), and (2, 14) in order from upper right, lower right, upper left, and lower left in FIG. 11B.

Furthermore, the maximum numbers of wiring lines for the tiles Tg2 (the numbers of allowed tile wiring lines) are calculated using the method described so far. As a result, the maximum numbers of wiring lines in the X direction and the Y direction are both 8.

Therefore, the states of the respective tiles Tg2 are as follows.

For a tile Tg2 at lower right, since the numbers of wiring lines (the numbers of tile wiring lines) are (3, 3), the wiring lines in both the X direction and the Y direction are not in a state of overflow. As a result, for the tile Tg2 at lower right, wiring design can be performed without changing their wiring directions.

For both tiles Tg2 at upper left and lower left, since the numbers of wiring lines (the numbers of tile wiring lines) are (2, 14), the wiring lines in the Y direction are in a state of overflow. However, by changing the configuration of partial wiring regions of each of the tiles Tg2 at upper left and at lower left from “four partial wiring line regions in the X direction and four partial wiring regions in the Y direction” to “one partial wiring region in the X direction and seven partial wiring regions in the Y direction”, a state where the wiring lines in both the X direction and the Y direction overflow can be avoided.

For a tile Tg2 at upper right, since the numbers of wiring lines (the numbers of tile wiring lines) are (14, 3), the wiring lines in the X direction are in a state of overflow. Even if the configuration of partial wiring regions of the tile Tg2 at upper right is changed, the state where the wiring lines overflow cannot be avoided. That is, a solution to the design cannot be obtained.

However, the tile Tg2 at upper right being in such a state is further divided into four tiles Tg3 such as those shown in FIG. 11C (in the example described here, a tile Tg3 is equivalent to a tile T). When the four tiles Tg3 are thus formed by dividing the tile Tg2, the numbers of wiring lines included in each tile Tg3 (the numbers of tile wiring lines) are as follows. Specifically, the numbers of wiring lines included in the tiles Tg3 (the X direction, the Y direction) are (7, 1), (7, 1), (6, 2), and (6, 2) in order from upper right, lower right, upper left, and lower left in FIG. 11C.

Furthermore, the maximum numbers of wiring lines for the tiles Tg3 (the numbers of allowed tile wiring lines) are, as described above, 4 for both of the wiring lines in the X and Y directions.

Therefore, the states of the respective tiles Tg3 are as follows.

For both tiles Tg3 at upper right and at lower right, since the numbers of wiring lines (the numbers of tile wiring lines) are (7, 1), the wiring lines in the X direction are in a state of overflow. However, by changing the configuration of partial wiring regions of each of the tiles Tg3 at upper right and at lower right from “four partial wiring line regions in the X direction and four partial wiring regions in the Y direction” to “seven partial wiring regions in the X direction and one partial wiring region in the Y direction”, a state where the wiring lines in both the X direction and the Y direction overflow can be avoided.

For both tiles Tg3 at upper left and at lower left, since the numbers of wiring lines (the numbers of tile wiring lines) are (6, 2), the wiring lines in the X direction are in a state of overflow. However, by changing the configuration of partial wiring regions of each of the tiles Tg3 at upper left and at lower left from “four partial wiring line regions in the X direction and four partial wiring regions in the Y direction” to “six partial wiring regions in the X direction and two partial wiring regions in the Y direction”, a state where the wiring lines in both the X direction and the Y direction overflow can be avoided.

By further dividing a tile Tg to form a plurality of tiles Tg2 and a plurality of tiles Tg3 in the above-described manner, wiring design can be effectively performed.

Next, a wiring design method of the present embodiment will be described.

The wiring design method of the present embodiment includes a plurality of steps. The flow of the steps is shown in a flowchart in FIG. 12.

Only those steps unique to the present embodiment will be described in detail below.

In the first and second embodiments, if a state where wiring lines overflow cannot be avoided at steps 4-4-1 and 5-4-1, then there is no solution to the wiring design and thus an error is output. In the present embodiment, however, in this step, the method proceeds to the next step without outputting an error. Specifically, the following steps are performed.

(Step 4-4-2) If the wiring lines in the Y direction overflow, then the method proceeds to step 6-1.

(Step 5-4-2) If the wiring lines in the X direction overflow, then the method proceeds to step 6-1.

Furthermore, in the present embodiment, the method has the following steps.

(Step 6-1) In this step, it is determined whether a tile Tg selected at step 3-2 can be further divided. If the selected tile Tg is equivalent to a tile T, then division cannot be performed. Therefore, if the selected tile Tg can be divided, then the method proceeds to step 6-2. On the other hand, if the selected tile Tg cannot be divided, then the method proceeds to step 6-4.

(Step 6-2) In this step, by the same method as that described at step 2-3, the tile Tg selected at step 3-2 is divided to form a plurality of tiles Tg2. At this time, each tile Tg2 is a group of a predetermined number of tiles T, and the number can be arbitrarily determined

Furthermore, by the same methods as those described at step 2-4, the numbers of wiring lines for the respective wiring directions that are included in each tile Tg2 (the numbers of tile wiring lines) and the maximum numbers of wiring lines for the respective wiring directions that can be included in each tile Tg2 (the numbers of allowed tile wiring lines) are calculated.

Then, the method proceeds to step 6-3.

(Step 6-3) In this step, the plurality of tiles Tg2 formed at step 6-2 is registered as unprocessed tiles. Then, the method proceeds to step 3-1.

Subsequently, as in the first embodiment, a plurality of tiles Tg2 is selected. Then, for the selected tiles Tg2, determination/processes are performed on the wiring lines in the X direction and then determination/processes are performed on the wiring lines in the Y direction.

Note that although here the case is described in which a series of processes are carried out for the wiring lines in the X direction first, and then a series of processes are performed on the wiring lines in the Y direction, a series of processes may be performed in switched order.

(Step 6-4) If it is determined at step 6-1 that the Tg cannot be further divided, then the processes for the Tg selected at step 3-2 are terminated (skipped), and the method proceeds to step 3-1 to perform processes for another the Tg.

Wiring design results can be obtained in the above-described manner.

According to the present embodiment, even when a solution to the design cannot be obtained in the wiring design method according to the second embodiment, wiring design can be performed easily without adding a wiring layer or reconsidering a floor plan. Accordingly, the time required for wiring design can be reduced. Furthermore, since the changing of wiring directions can be considered on a tile-by-tile basis, satisfactory optimization of the wiring directions of wiring layers can be achieved.

According to the first to third embodiments described above, wiring design can be performed easily without adding a wiring layer or reconsidering a floor plan. Accordingly, the time required for wiring design can be reduced.

Note that the wiring design methods of the embodiments described above can be configured by software. In the case of configuring by software, a program that implements at least part of a wiring design method may be stored in a recording medium, such as a flexible disk or a CD-ROM, and may be loaded onto a computer and executed. The recording medium is not limited to a removable recording medium such as a magnetic disk or an optical disk, and may be a fixed recording medium such as a hard disk apparatus or a memory.

In addition, a program that implements at least part of a wiring design method may be distributed through a communication line (also including wireless communication) such as the Internet. Furthermore, the program may be encrypted or modulated or compressed, and the resulting program may be distributed through a wired or wireless line such as the Internet, or may be stored in a recording medium and distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method for determining a schematic wiring design, implemented on a computer device, comprising:
dividing a substrate into a plurality of tiles, the substrate comprising a first wiring layer and a second wiring layer, the first wiring layer comprising a first plurality of wiring lines and the second wiring layer comprising a second plurality of wiring lines;
dividing a portion of the first wiring layer into a first plurality of partial wiring regions;
dividing a portion of the second wiring layer into a second plurality of partial wiring regions;
determining that a number of the wiring lines of the first and second pluralities of wiring lines oriented in a first direction in the tile exceeds a threshold; and
modifying the wiring direction of a partial wiring region of the first plurality of wiring regions from a second direction to the first direction.

2. The method for determining a schematic wiring design according to claim 1, wherein the first direction is perpendicular to the second direction.

3. The method for determining a schematic wiring design according to claim 1, further comprising:
determining that a number of the wiring lines of the first and second pluralities of wiring lines oriented in the second direction in the tile exceeds a threshold; and
modifying the wiring direction of a partial wiring region of the first plurality of wiring regions from the first direction to the second direction.

4. The wiring design method according to claim 1, wherein the tile corresponds to a plurality of cells, the cells determined by dividing the substrate into a grid pattern, the grid pattern estimating a degree of wiring line congestion in the schematic wiring design.

5. The method for determining a schematic wiring design according to claim 4, further comprising forming the plurality of tiles by moving a plurality of cells in a first direction and a second direction by predetermined distances.

6. The method for determining a schematic wiring design according to claim 1, wherein the tile comprises a plurality of secondary tiles, where each of the secondary tiles corresponds to a plurality of cells, the plurality of cells determined by dividing the substrate into a grid pattern to estimate a degree of wiring line congestion in the schematic wiring design.

7. The method for determining a schematic wiring design according to claim 6, further comprising:
dividing a partial wiring region of the first plurality of partial wiring regions into a plurality of secondary partial wiring regions, where each of the secondary partial wiring region corresponds to one or more of the secondary tiles,
determining that a number of wiring lines of the secondary tiles oriented in the first-direction exceed a threshold; and
modifying the wiring direction of a secondary partial wiring region of the plurality of secondary partial wiring regions from the second direction to the first direction.

8. The method for determining a schematic wiring design according to claim 7, wherein the tile comprises a number of wiring lines in the first direction exceeding a threshold before the division.

9. A non-transitory computer readable medium comprising instructions that cause a computer to perform the following:
dividing a substrate into a plurality of tiles, the substrate comprising a first wiring layer and a second wiring layer, the first wiring layer comprising a first plurality of wiring lines and the second wiring layer comprising a second plurality of wiring lines;
dividing a portion of the first wiring layer into a first plurality of partial wiring regions;
dividing a portion of the second wiring layer into a second plurality of partial wiring regions;
determining that a number of the wiring lines of the first and second pluralities of wiring lines oriented in a first direction in the tile exceeds a threshold; and
modifying the wiring direction of a partial wiring region of the first plurality of wiring regions from a second direction to the first direction.

10. The computer-readable medium according to claim 9, wherein the first direction is perpendicular to the second direction.

11. The computer-readable medium according to claim 9, wherein the program instructions cause the computer to further perform:
determining that a number of the wiring lines of the first and second pluralities of wiring lines oriented in the second direction in the tile exceeds a threshold; and
modifying the wiring direction of a partial wiring region of the first plurality of wiring regions from the first direction to the second direction.

12. The computer-readable medium according to claim 9, wherein the tile corresponds to a plurality of cells, the cells determined by dividing the substrate into a grid pattern, the grid pattern estimating a degree of wiring line congestion in the schematic wiring design.

13. The computer-readable medium according to claim 12, wherein the tiles are formed by moving a plurality of cells in a first direction and a second direction by predetermined distances.

14. The computer-readable medium according to claim 9, wherein the tile comprises a plurality of secondary tiles, where each of the secondary tiles corresponds to a plurality of cells, the plurality of cells determined by dividing the substrate into a grid pattern to estimate a degree of wiring line congestion in the schematic wiring design.

15. The computer-readable medium according to claim 14, wherein the program instructions cause the computer to further perform:
dividing a partial wiring region of the first plurality of partial wiring regions into a plurality of secondary partial wiring regions, where each of the secondary partial wiring region corresponds to one or more of the secondary tiles,
determining that a number of wiring lines of the secondary tiles oriented in the first-direction exceed a threshold; and
modifying the wiring direction of a secondary partial wiring region of the plurality of secondary partial wiring regions from the second direction to the first direction.

16. The computer-readable medium according to claim 15, wherein the tile comprises a number of wiring lines in the first direction exceeding a threshold before the division.
